(19) United States
(12) Patent Application Publication
(10) Pub. No.: US 2020/0272526 A1
(43) Pub. Date: Aug. 27, 2020

(54) Methods and systems for automated scaling of computing clusters

(71) Applicant: ESDS Software Solution Pvt. Ltd, Maharashtra (IN)

(72) Inventors: Narendra BHOLE, Maharashtra (IN); Prajakta SOMANI, Maharashtra (IN); Rushikesh JADHAV, Maharashtra (IN); Rajeev PAPNEJA, Maharashtra (IN); Piyush SOMANI, Maharashtra (IN)

(21) Appl. No.: 16/797,660

(22) Filed: Feb. 21, 2020

(30) Foreign Application Priority Data
Feb. 21, 2019 (IN) 201921006913

(51) Int. Cl. G06F 9/50; G06F 11/34; H04L 29/08; H04L 12/24; G06F 9/455

(52) U.S. Cl. CPC G06F 9/5077; G06F 9/5083; G06F 11/3409; G06F 2009/4557; H04L 41/0893; G06F 9/45558; G06F 2209/505; H04L 67/10

(57) ABSTRACT

Methods and systems for automated scaling of computing clusters. A method disclosed herein includes determining a scaling scheme for scaling a computing cluster to perform at least one operation of storing data, and processing the data related to at least one application. The scaling scheme includes one of a vertical scaling, a horizontal scaling, and a diagonal scaling. The vertical scaling involves allocating/de-allocating resources for at least one master node of the computing cluster. The horizontal scaling involves adding new slave nodes to the computing cluster. The diagonal scaling includes a combination of the horizontal scaling and the vertical scaling.

### CROSS REFERENCE TO RELATED APPLICATION

This application is based on and derives the benefit of Indian Provisional Application 201921006913, the contents of which are incorporated herein by reference.

### TECHNICAL FIELD

Embodiments disclosed herein relate to distributed computing systems, and more particularly to automated two-way scaling of computing clusters within a distributed computing system.

### BACKGROUND

In a distributed computing system (for example: Hadoop), computing clusters include a plurality of computing nodes that may operate jointly for performing operations such as, but not limited to, processing and generating data sets, storing data sets, and so on. A speed of such operations may be increased by scaling the computing clusters. The computing clusters may be scaled by adding/removing one or more computing nodes from the clusters.

In conventional approaches, a programming model (such as MapReduce) may be employed for processing and generating the data sets by supporting the scaling of the clusters. Considering the example of MapReduce, MapReduce includes two functions, namely, a map function, and a reduce function. The map function may split the data sets into smaller chunks (data sets), and distribute the smaller chunks to the plurality of computing nodes in the cluster for an initial ‘map’ stage of processing. The reduce function enables the plurality of computing nodes to carry out a second ‘reduce’ stage of processing based on results of the ‘map’ stage, thereby dynamically increasing processing power and processing speed. MapReduce also supports the scaling of the cluster by enabling adding or removing of one or more computing nodes from the cluster. However, the computing nodes can be added or removed manually, that is on receiving sequential operations from a system administrator. Therefore, the computing nodes can be under or over provisioned with delay/downtime due to the manual process.

### OBJECTS

The principal object of embodiments herein is to disclose methods and systems for automating scaling of at least one computing cluster in a distributed computing system, wherein the scaling includes a vertical scaling, or a horizontal scaling, or a diagonal scaling, wherein the diagonal scaling includes a combination of both the horizontal scaling and vertical scaling.

Another object of embodiments herein is to disclose methods and systems for performing the vertical scaling to scale at least one master node in the at least one computing cluster.

Another object of embodiments herein is to disclose methods and systems for performing the horizontal scaling to scale at least one slave node in the at least one computing cluster.

Another object of embodiments herein is to disclose methods and systems for performing the diagonal scaling to scale the at least one master node as well as to scale the at least one slave node in the at least one computing cluster.

Another object of embodiments herein is to disclose methods and systems for determining the scaling or tuning the scaling by monitoring and debugging the computing clusters in real-time.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, through out which like reference letters indicate corresponding parts in the various figures. The embodiments herein will be better understood from the following description with reference to the drawings, in which:

FIG. 1 depicts a distributed computing system, according to embodiments as disclosed herein;

FIGS. 2a and 2b depict a computing cluster of the distributed computing system, according to embodiments as disclosed herein;

FIG. 3 is a block diagram depicting various modules of the master node for determining the scaling scheme for the computing cluster, according to embodiments as disclosed herein;

FIG. 4 is an example diagram depicting vertical scaling performed for the master node in the computing cluster, according to embodiments as disclosed herein;

FIG. 5 is an example diagram depicting horizontal scaling performed for the slave nodes in the computing cluster, according to embodiments as disclosed herein;

FIG. 6 is an example flow diagram depicting a method for performing the vertical scaling, according to embodiments as disclosed herein;

FIG. 7 is an example flow diagram depicting a method for performing the horizontal scaling, according to embodiments as disclosed herein; and

FIG. 8 is an example flow diagram depicting a method for performing the diagonal scaling, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Embodiments herein perform automated scaling of computing clusters in a distributed computing system, wherein the scaling includes a vertical scaling for scaling at least one master node in the at least one computer cluster or a horizontal scaling for scaling at least one slave node in the at least one computer cluster, or a diagonal scaling that involves a combination of the vertical scaling and a horizontal scaling.

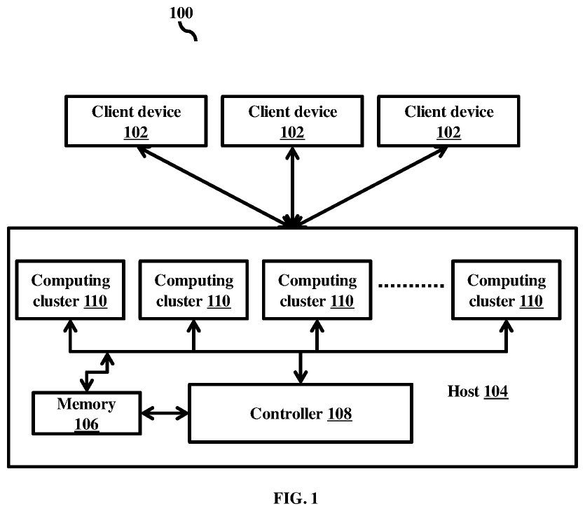

Referring now to the drawings, and more particularly to FIGS. 1 through 8, where similar reference characters denote corresponding features consistently throughout the figures, there are shown embodiments.

FIG. 1 depicts a distributed computing system 100, according to embodiments as disclosed herein. The distributed computing system 100 referred herein can be configured for distributed storage and processing of data sets across a scalable cluster of computers, thereby providing more flexibility to users/customers/clients for collecting, processing and analyzing the data. Examples of the distributed computing system 100 can be at least one of Hadoop, big data systems, and so on. The distributed computing system 100 includes a plurality of client devices 102, and a host 104.

The client device(s) 102 referred herein can be any computing device used by a user/client. Examples of the client device 102 can be, but is not limited to, a mobile phone, a smartphone, a tablet, a phablet, a personal digital assistant (PDA), a laptop, a computer, an electronic reader, an IoT (Internet of Things) device, a wearable computing device, a medical device, a gaming device, or any other device that is capable of interacting with the host 104 through a communication network. Examples of the communication network, can be, but is not limited to, a wired network (a Local Area Network (LAN), Ethernet and so on), a wireless network (a Wi-Fi network, a cellular network, a Wi-Fi Hotspot, Bluetooth, Zigbee or the like), and so on. The client device 102 can interact with the host 104 for accessing data such as, but not limited to, media (text, video, audio, image, or the like), data/data files, event logs, sensor data, network data, enterprise data, and so on.

The host 104 referred herein can be at least one of a computer, a cloud computing device, a virtual machine instance, a data centre, a server, a network device, and so on. The cloud can be a part of a public cloud or a private cloud. The server can be at least one of a standalone server, a server on a cloud, or the like. Examples of the server can be, but is not limited to, a web server, an application server, a database server, an email-hosting server, and so on. Examples of the network device can be, but is not limited to, a router, a switch, a hub, a bridge, a load balancer, a security gateway, a firewall, and so on. The host 104 can support a plurality of applications such as, but not limited to, an enterprise application, data storage applications, media processing applications, email applications, sensor related applications, and so on.

The host 104 can be configured to perform at least one operation related to the at least one application on receiving requests from the at least one client device 102 and/or user. The at least one operation involves at least one of storing data related to the at least one application, processing the data related to the at least one application, fetching the data related to at least one application, and so on. Examples of the data can be, but not limited to, media (text, video, audio, image, or the like), data files, event logs, router logs, network data, sensor data, performance data, enterprise data, and so on.

The host 104 includes a memory 106, a controller 108, and a plurality of computing clusters 110. The host 104 can also include a display, an Input/Output interface, a processor, and so on. The host 104 may also communicate with external devices such as, but not limited to, other hosts, external servers, external databases, networks, and so on using the communication network.

The memory 106 can store at least one of the content, the application, the requests from the client devices 102, the data related to the at least one application, information about the computing clusters 110, and so on. Examples of the memory 106 can be, but not limited to, NAND, embedded Multi Media Card (eMMC), Secure Digital (SD) cards, Universal Serial Bus (USB), Serial Advanced Technology Attachment (SATA), solid-state drive (SSD), data servers, file storage servers, and so on. The memory 106 may also include one or more computer-readable storage media. The memory 106 may also include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 106 may, in some examples, be considered a non-transitory storage medium. The term “non-transitory” may indicate that the storage medium is not embodied in a carrier wave or a propagated signal. However, the term “non-transitory” should not be interpreted to mean that the memory 106 is non-movable. In certain examples, a non-transitory storage medium may store data that can, over time, change (e.g., in Random Access Memory (RAM) or cache).

The controller 108 can be at least one of a single processor, a plurality of processors, multiple homogeneous or heterogeneous cores, multiple Central Processing Units (CPUs) of different kinds, microcontrollers, special media, and other accelerators. Also, the controller 108 can be at least one of a datacenter controller, a fabric controller or other suitable types of controller.

The controller 108 can be configured to manage adding/removing of the computing clusters 110 to/from the host 104 by maintaining information about the computing clusters 110 in the memory 106. The controller 108 can also be configured to distribute the applications across the plurality of computing clusters 110, so that one or more operations related to the applications can be performed by the devices in the clusters to which the applications have been distributed. The devices in the clusters to which the applications have been distributed, can perform the operations in parallel with increased speed and efficiency on receiving the requests from the at least one client device 110. The controller 108 can also enable the plurality of computing clusters 110 hosting the plurality of applications to connect to the at least one client device 102 based on their requests. For example, the controller 108 may distribute a media processing application across two computing clusters 110, wherein a first computing cluster can perform the operation of storing the data related to the media processing application and a second computing cluster can perform the operation of processing the data related to the media processing application. The controller 108 can enable the first computing cluster to connect to the client device 102 on receiving the request from the client device 102 for performing the operation of storing the data related to the media processing application.

The controller 108 also allocates resources to the computing clusters 110 for performing the operations related to the at least one application. Examples of the resources can be, but not limited to, computing resources (Central Processing Unit (CPU), processors, or the like), data storage, network resources, Random Access Memory (RAM), disk space, input/output operations, and so on.

The plurality of computing clusters 110 referred herein can be instance groups configured for performing the at least one operation related to the at least one application on receiving the requests from the at least one client device 102.

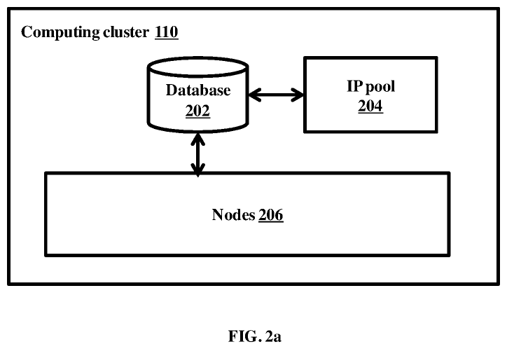

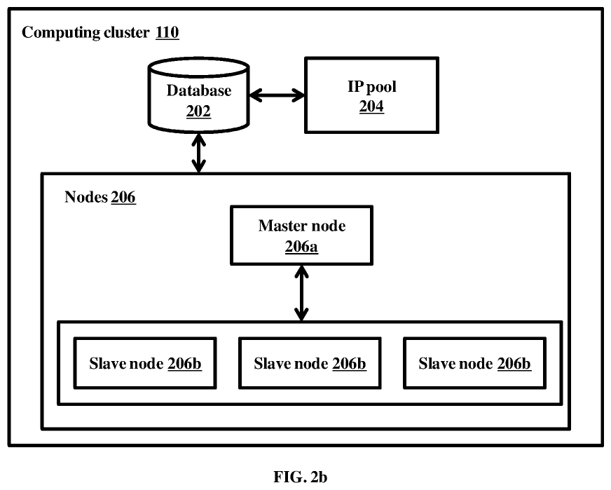

As illustrated in FIG. 2a, the computing cluster(s) 110 includes a database 202, an Internet Protocol (IP) pool 204, and a plurality of nodes 206. The database 202 can be configured to maintain information about the executing/active nodes 206 and their associated addresses in the IP pool 204. The addresses can include at least one of the IP addresses, and Media Access Control (MAC) addresses. The addresses being allocated to nodes 206 can be addresses that are pre-defined as per the available architecture of computing system 100/computing clusters 110. Also, the addresses stored in the IP pool 204 can be used for allocating to newly created nodes 206. The nodes 206 can use any of the addresses from the allocated subnet of the addresses that is stored in the IP pool 204.

The plurality of nodes 206 can be instance/working nodes that can be configured to perform the at least one operation related to the at least one application such as, but not limited to, processing the data, storing the data, and so on. Examples of the nodes can be, but is not limited to, a virtual machine, or any other virtualized component. Each node 206 can be assigned with at least one type of address to distinguish the nodes 206 from each other. In an example herein, the address can be at least one of an IP address, a Media Access Control (MAC) address, and so on. The address of each node 206 can be stored in the IP pool 204. The plurality of nodes 206 can communicate with each other using Secure Shell protocol (SSH). Further, the controller 108 enables the plurality of nodes 206 to connect with the at least one client device 102. In an example herein, the controller 108 may host the computing cluster 110 comprising of three nodes 206 and enable the three nodes 206 in the cluster to connect to three client devices 102 individually. In an example herein, the controller 108 may host the computing cluster 110 comprising of two nodes 206 and enable the two nodes 206 in the cluster to connect to the single client device 102.

In an embodiment, the plurality of nodes 206 can be scalable, so that the nodes 206 can be added or removed/terminated by the controller 208 based on requirements for performing the at least one operation related to the at least one application.

As illustrated in FIG. 2b, the plurality of nodes 206 in the cluster 110 includes at least one master node 206a, and one or more slave nodes 206b.

The master node 206a can be a core node that is configured to host the at least one application or have access to the at least one application. The master node 206a can perform the at least one operation related to the hosted at least one application on receiving the requests from the at least one client device 102 for the hosted at least one application. The operations may involve storing the data, performing parallel computation/processing on the stored data, and so on. Examples of the data can be, but is not limited, to media, data files, event logs, sensor data, performance data, machine data, and so on. The master node 206a can also be configured to report the controller 108 about details such as, but not limited to, status of the at least one application, status of the at least operation, completion of the at least one operation, and so on. The master node 206a also receives the computing resources required for performing the at least one operation from the controller 108. The master node 206 includes a name node for handling data storage function, a job tracker node for monitoring the parallel computation/processing of the data, and a secondary name node as a backup of the name node.

The master node 206 can also be configured to manage operations of the slave nodes 206b by maintaining information about the slave nodes 206b in the database 202. The master node 206 can also be configured to divide the requested operation into tasks (hereinafter the term “operations' can be used interchangeably for the tasks) and assign the divided tasks for the slave nodes 206b, wherein the tasks can be at least one of storing the data and/or part of the data related to the at least one application, processing/computing the data and/or part of the data, and so on. The master node 206a can divide and assign the tasks to the slave nodes 206b by tracking a task threshold set for each slave node 206b. The task threshold defines a number/amount of tasks, which can be managed by each slave node 206b. The master node 206 can further add one or more slave nodes 206b for performing the assigned tasks and can remove one or more slave nodes 206b after completion of the respective assigned tasks. Embodiments herein use the terms such as, “master node”, “core node”, “name node”, and so on interchangeably to refer to a node in the computing cluster 110 having both the data storage and processing capabilities and managing at least one other node.

The slave nodes 206b can be a task node/worker node that can be configured to perform the tasks assigned by the at least one master node 206a. The slave nodes 206b can communicate with the master node 206a by sending heartbeat signals to the master node 206a. Each of the slave nodes 206b includes a data node and a task tracker. The data node can communicate with the master node 206a to receive the tasks. The data node can report to the master node 206a about the status and completion of the tasks. The task tracker can be a backup node for the data node. Embodiments herein use the terms such as, “slave node”, “task node”, “worker node”, “data node”, and so on interchangeably to refer to a node in the computing cluster 110 that performs the tasks assigned from the master node 206a.

Embodiments herein enable the master node 206a to determine a scaling scheme for scaling up or scaling down the associated computing cluster 110 in order to perform the at least one operation related to the at least one application or to speed up the at least one operation. The scaling up or scaling down the computing cluster 110 involves adding or removing the resources (for example: the computing resources, the disk space, the RAM, or the like), the slave nodes 206b, and so on. The determined scaling scheme includes one of a vertical scaling, a horizontal scaling, and a diagonal scaling. In an embodiment, the vertical scaling can be for the master node 206a itself and involves adding or removing the resources for the master node 206a. In an embodiment, the horizontal scaling can be for the slave nodes 206b and involves adding the new slave nodes 206b to the computing cluster 110. In an embodiment, the diagonal scaling can be a combination of both the horizontal and vertical scaling of the slave nodes 206b and the master node 206a respectively. The horizontal scaling of the slave nodes 206b involves adding the slave nodes 206b to the associated computing cluster 110 and the vertical scaling of the slave nodes 206b involves adding or removing the resources for the slave nodes 206b.

In an embodiment, for determining the vertical scaling, the master node 206b collect its own metrics continuously or at the pre-determined intervals or on an occurrence of pre-defined events. The pre-defined events, can be, but not limited to, maximum utilization of the resources, failure of any nodes 206, and so on. Examples of the metrics can be, but is not limited to, load, health (for example; detecting failure of the node 206, or the like), the allocated resources (for example: the computing resources, the disk space, the RAM, or the like), and so on. The master node 206a can also collect the requests from the client devices 102 in real-time. The requests can be for performing the at least one operation related to the at least one application hosted on the master node 206a.

Based on the collected metrics of its own, and the requests received from the at least one client device 102, the master node 206a determines the resources required for performing the current operation or performing the at least one operation requested by the at least one client device 102. The resources required for performing the at least one operation related to the at least one application can be pre-defined/benchmarked based on time set for the completion of the corresponding at least one operation related to the at least one application. Also, the required resources (such as the RAM, the disk space, and so on) can be pre-defined for the at least one application based on per client record processing. The master node 206a maintains a mapping of the resources required for the plurality of operations of the plurality of applications. The master node 206a uses the collected metrics of its own, the received request and the maintained mapping of the resources required for the plurality of operations of the plurality of applications to determine the resources required for performing the at least one requested operation. In an embodiment, the master node 206a compares the required resources with the resources available for the master node 206a at a current instance of time and checks if additional resources are required for performing the at least one operation. On checking that the master node 206a requires the additional resources, the master node 206a determines the vertical scaling as the scaling scheme to scale up the resources for itself. The master node 206a reports to the controller 108 about the required resources. In response to the received report, the controller 108 allocates the required additional resources for the master node 206a.

In an embodiment, the master node 206a compares the required resources with the resources available for the master node 206a at a current instance of time and checks if the available resources are underutilized or may be underutilized (based on the current pending operations). On checking that the available resources are being/may be underutilized, the master node 206a determines the vertical scaling to de-allocate/de-scale the resources for itself. The master node 206a reports to the controller 108 about the resources that can be de-scaled. The controller 108 further de-allocates the reported resources from the master node 206a.

In an embodiment, for determining the horizontal scaling, the master node 206a can monitor and collect metrics from the associated slave nodes 206b (that are performing the at least one task) continuously or at pre-determined intervals or on occurrence of pre-defined events. The pre-defined events, can be, but is not limited to, a maximum utilization of resources by the slave nodes 206b, allocation/de-allocation of the slave nodes 206b, or the like. For example, consider that the slave node 206b has 4 GB of Random Access Memory (RAM). If the slave node 206b utilizes 3.5 GB, then the pre-defined event trigger is initiated. The master node 206a sends a command to slave nodes 206b using at least one protocol continuously or at the pre-determined intervals or on the occurrence of pre-defined events and collects the metrics of the slave nodes 206b. Examples of the protocols can be, but not limited to, Simple Network Management Protocol (SNMP), the SSH protocol, Windows Management Instrumentation (WIM) protocol, an agent communication, and so on.

Based on the collected metrics of the slave nodes 206b, and the requests received from the at least one client device 102, the master node 206a determines the resources available on the slave nodes 206b at the current instance of time. The master node 206a then compares the resources available on the slave nodes 206b with resource thresholds corresponding to the respective slave nodes 206b. The resource thresholds indicate a minimum number/amount of resources that can be pre-defined for the slave nodes 206b. If the resources available on the slave nodes 206b cross the resource thresholds corresponding to the respective slave nodes 206b (for example, if the available resources are lesser than the resource threshold), the master node 206a determines the horizontal scaling to add a number of new slave nodes 206b to the computing cluster 110. For example herein, consider that the salve nodes 206b having 20 GB of storage are present in the computing cluster 110 and the resource threshold of 5 GB storage is set for the slave nodes 206b. When the storage available on the slave nodes 206b crosses the resource threshold (that is when the storage available on the slave nodes 206b is lesser than 5 GB), the master node 206a determines the horizontal scaling for adding the new/additional slave nodes 206b to the computing cluster 110. The master node 206b can report about the determined horizontal scaling to the controller 108. In response to the received report, the controller 108 adds the determined number of additional/new nodes to the corresponding cluster 110 through a HSG interface. The HSG interface creates additional nodes when there is a resource requirement from the master node 206a. In an example herein, the HSG interface can create the new slaves nodes as virtual machines/new machines instead of adding the resources to the existing slave nodes 206b in the computing cluster 110. The additional/newly added slave nodes 206b may perform an initialization operation to register on the master node 206a, so that the master node 206a can distribute the tasks across the newly added slave nodes 206b. In an embodiment, the newly added slave nodes 206b may automatically register on the master node 206b using a template/inbuilt script for auto-commissioning and an IP address of the corresponding master node 206b. The master node 206b may also store the template of the newly added slave nodes 206b, so that the newly added slave nodes 206b can execute the template during a startup operation/boot up operation to register with the master node 206a. Thus, the automatic scaling increases performance and storage capacity of the host.

In an embodiment, for performing the diagonal scaling, the master node 206a collects the metrics of its own, and the slave nodes 206b, and the client requests continuously or at the pre-determined intervals or on the occurrence of the pre-defined events. Based on the collected metrics and the client requests, the master node 206a determines the resources available on the master node 206a and the resources available on the slave nodes 206b at the current instance of time. The master node 206a determines the diagonal scaling to add/remove the resources for itself by comparing its available resources with the resources required for performing the at least one operation and to add the new slave nodes 206b to computing cluster 110 by comparing the resources available on the slave nodes 206b with the resource thresholds corresponding to the respective slave nodes 206b. The master node 206a reports to the controller 108 about the diagonal scaling. The controller 108 then adds/removes the resources to/from the master node 206a and adds the new slave nodes 206b to the computing cluster 110.

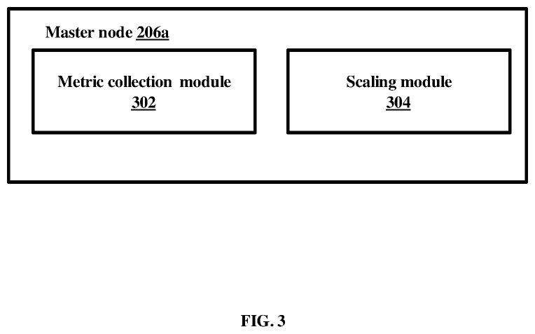

FIG. 3 is a block diagram depicting various modules of the master node 206a for determining the scaling scheme for the computing cluster 110, according to embodiments as disclosed herein. The master node 206a includes a metric collection module 302, and a scaling module 304.

The metric collection module 302 can be configured to collect the metrics of the slave nodes 206b and the master node 206a. Examples of the metrics can be, but not limited to, the load, the allocated resources for the nodes 206, the available resources of the nodes 206, the health of the nodes 206, and so on. In an embodiment, the metric collection module 302 may collect the metrics continuously/in real-time. In an embodiment, the metric collection module 302 may collect the metrics at the pre-defined intervals. In an embodiment, the metric collection module 302 may collect the metrics on the occurrence of pre-defined events (such as allocation of an occurrence, scaling/de-scaling the nodes, and so on). For collecting the metrics of the slave nodes 206b, the metric collection module 302 sends the command to the slave nodes 206 continuously or at the pre-defined intervals, or on the occurrence of the pre-defined events over at least one of the SNMP, the SSH protocol, the agent communication, and so on. The metric collection module 302 receives the metrics from the slave nodes 206b in response to the sent command.

The metric collection module 302 can also be configured to receive the requests from the at least one client device 102/user in real-time for performing the at least one operation related to the at least one application hosted on the master node 206a. In an example, the requests can be, but not limited to, Hyper Text Transfer Protocol (HTTP) requests. The metric collection module 302 provides the collected metrics and the received requests to the scaling module 304.

The scaling module 304 can be configured to determine the vertical scaling or the horizontal scaling or the diagonal scaling as the scaling scheme for scaling the master node 206a and/or the slave nodes 206b of the computing cluster 110.

For determining the vertical scaling, the scaling module 304 analyzes the collected metrics and received requests and determines the amount of resources required for performing the at least one operation (that can be the current operation or the at least one operation specified in the received request) related to the at least one application. The amount of resources required for performing the at least one operation can be pre-defined based on the time defined for completion of the at least one operation or based on the per client record processing. The resources can be at least one of the computing resources (the CPU, or the like), the disk space, the RAM, the network resources, and so on. In an embodiment, the scaling module 304 determines the required resources as minimum amount of resources required for the master node 206a to perform the at least one operation, and maximum amount of resources required for the master node 206a to perform the at least one operation. The minimum value can be a downscale limit of resources that the node 206a may not downscale below this limit/minimum value. The maximum value can be an upscale limit of resources that the node 206a may not upscale beyond this limit. The scaling module 304 also analyzes the collected metrics and determines the available amount of resources on the master node 206a at the current instance of time.

The scaling module 304 compares the available amount of resources on the master node 206a with the minimum amount of resources and the maximum amount of resources determined for the master node 206a to perform the at least one operation. If the available amount of resources on the master node 206a is between the determined minimum and maximum amount of resources, the scaling module 304 determines that the available amount of resources is sufficient enough for the master node 206a to perform the at least one operation.

If the available amount of resources on the master node 206a is less than the determined minimum amount of resources, the scaling module 304 determines that the master node 206a requires the additional amount of resources for performing the at least one operation. Thereafter, the scaling module 304 determines the vertical scaling as the scaling scheme for adding/scaling up the required additional amount of resources for the master node 206a. The scaling module 304 determines the required amount of additional resources for the master node 206a. The required amount of resources to add/allocate can be determined using the available resources on the master node 206a and the determined minimum resources. The scaling module 304 communicates the determined required amount of resources to the controller 108 and requests the controller 108 to allocate the determined required amount of resources for the master node 206a.

If the available amount of resources on the master node 206a is more than the determined maximum resources, the scaling module 304 determines that the available amount of resources may be underutilized. The scaling module 304 decides the vertical scaling as the scaling scheme for de-allocating/de-scaling the resources for the master node 206a. The scaling module 304 determines the amount of resources to be de-allocated from the master node 206a. The amount of resources to de-allocate can be determined using the available amount of resources and the determined maximum required amount of resources. The scaling module 304 communicates the determined amount of resources to de-allocate to the controller 108 and requests the controller 108 to de-allocate the determined amount of resources for the master node 206a.

In an embodiment, for determining the horizontal scaling, the scaling module 304 analyzes the collected metrics of the slave nodes 206b, and the received requests and determines the resources available on the slave nodes 206b at the current instance of time, and the resources required for performing the at least one operation. The scaling module 304 compares the resources available on the slave nodes 206b with the resources thresholds corresponding to the respective slave nodes 206b. If the resources available on the slave nodes 206b are greater than (do not cross) the resource thresholds, the scaling module 304 determines that the slave nodes 206b that have already present in the computing cluster 110 are sufficient to perform the at least one operation. If the available resources of the slave nodes 206b are lesser than the resource thresholds (that cross the resource thresholds), the scaling module 304 decides the horizontal scaling for adding the new slave nodes 206b to the computing cluster 110. For example, consider that the computing cluster 110 includes 4 slave nodes 206b of 20 GB disk space, wherein each slave node 206b is associated with the pre-defined resource threshold of 3 GB. In such a scenario, the scaling module 304 determines the disk space available on the 4 slave nodes 206b at the current instance of time based on the collected metrics of the slave nodes 206b. If the disk space available on the 4 slave nodes 206b is greater/does not cross the resource threshold of 3 GB, the scaling module 304 determines that the present 4 slave nodes are sufficient for performing the at least one operation. If the disk space available on the 4 slave nodes 206b is lesser/crosses the resource threshold of 3 GB, the scaling module 304 determines the horizontal scaling to add the new slave nodes for performing the at least one operation.

The scaling module 304 determines the number of new slave nodes 206b to be added to the computing cluster 110 based on the determined resources required for performing the at least one operation related to the at least one application. The scaling module 304 communicates the determined number of new slave nodes 206b to be added to the controller 108 and requests the controller 108 to add the determined new slave nodes 206b to the computing cluster 110.

In an embodiment, for determining the diagonal scaling, the scaling module 304 analyzes the collected metrics of its own and of the slave nodes 206b and the received requests and determines the resources available on the slave nodes 206b, the resources available on the master node 206a, and the resources required for performing the at least one operation. The scaling module 304 then compares the resources available on the master node 206a with the maximum and minimum amount of resources required for performing the at least one operation. The scaling module 304 also compares the resources available on the slave nodes 206b with the resources thresholds corresponding to the respective slave nodes 206b. If the resources available on the master node 206a is more than the minimum amount of resources required for performing the at least one operation and the resources available on the slave nodes 206b is lesser than the resource thresholds, then the scaling module 304 decides the diagonal scaling to add the resources for the master node 206a and to add the new slave nodes to the computing cluster 110. If the resources available on the master node 206a is more than the maximum amount of resources required for performing the at least one operation and the resources available on the slave nodes 206b is lesser than the resource thresholds, then the scaling module 304 decides the diagonal scaling to remove the resources for the master node 206a and to add the new slave nodes to the computing cluster 110. The scaling module 304 further determines the amount/number of resources to be added/removed for the master node 206a and the number of new slave nodes 206b to be added to the computing cluster 110 based on the resources required for the at least one operation. The scaling module 304 then communicates the determined amount of resources to add/remove for the master node 206a and the determined number of new slave nodes 206b to the controller 108. The scaling module 304 requests the controller 108 to perform the diagonal scaling for adding/removing the determined resources for the master node 206a and for adding the determined number of slave nodes 206b to the computing cluster 110.

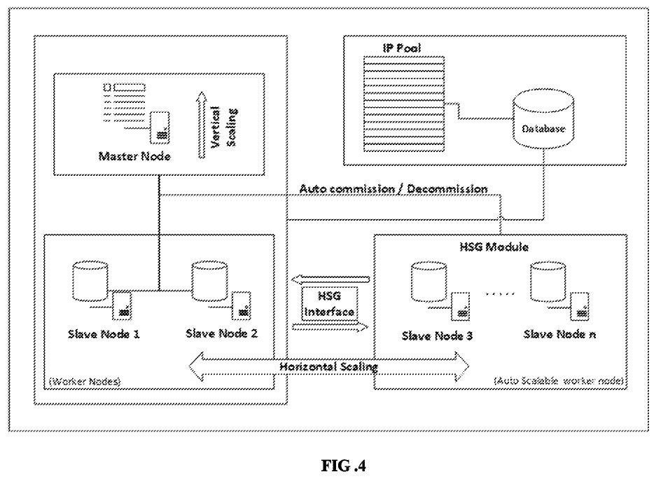

FIG. 4 is an example diagram depicting the vertical scaling performed for the master node 206a in the computing cluster 110, according to embodiments as disclosed herein. Consider an example scenario as illustrated in FIG. 4, wherein the master node 206a is coupled with core slave nodes 206b that can perform the at least one task of processing the data and storage slave nodes 206b that can perform the at least one task of storing the data. In such a case, the master node 206a collects the metrics of its own and the metrics of the slave nodes 206a such as, but not limited to, load (the number of slave nodes 206b that the master node 206a is managing), health, status of the at least one operation, and so on. In an example herein, based on the collected metrics and the requests received from the at least one client device 102, the master node 206a determines there is a requirement for 50 GB storage (disk space) and 4 GB of RAM for performing/speeding up the at least one operation. The master node 206 further determines the available amount of disk storage and the RAM on it. In an example herein, consider that 45 GB of disk space and 2 GB of RAM are available on the master node 206a. In such a case, the master node 206 determines that the additional 5 GB of disk space and 2 GB of RAM are required for it for performing the at least one operation. The master node 206 requests the controller 108 to initiate the vertical scaling for allocating the additional 5 GB of disk space and 2 GB of RAM for it, so that the master node 206a can complete the at least one operation with increased speed.

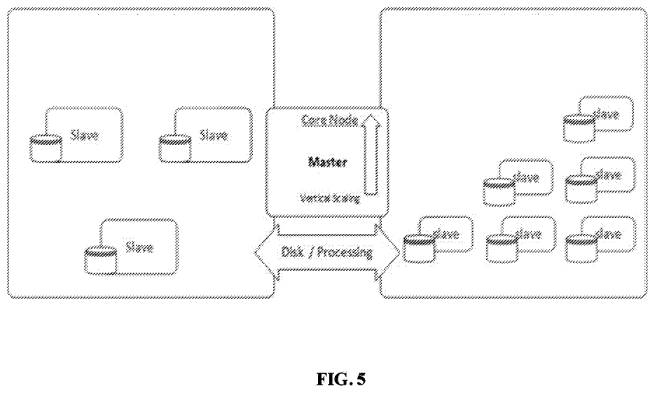

FIG. 5 is an example diagram depicting the horizontal scaling performed for the slave nodes 206b in the computing cluster 110, according to embodiments as disclosed herein. Consider an example scenario as depicted in FIG. 5, wherein the master node 206a is coupled with the two slave nodes 206b (a slave node 1 with 30 GB storage and a slave node 2 with 30 GB storage). In such a scenario, the master node 206a collects the metrics of the slave node 1 and the slave node 2 in real-time and analyzes the collected metrics, and the requests from the client device 102 for determining the available storage (resources) on the slave node 1 and the slave node 2 at the current instance of time and the resources required for the at least one operation. In an example herein, consider that 2 GB of storage is available on the slave node 1 and the slave node 2 at the current instance of time. The master node 206a then compares the storage available on the slave node 1 with the resource threshold defined for the slave node 1 (for example: 5 GB) and the storage available on the slave node 2 with the resource threshold defined for the slave node 2 (for example; 4 GB). As, the storage available on the slave node 1 and the slave node 2 (for example: 2 GB) are lesser than the resource thresholds corresponding to the slave node 1 and the slave node 2, the master node 206a determines the horizontal scaling to add the new slave nodes to the computing cluster 110. In an example herein, consider that the master node 206b determines to add two new slave nodes (a slave node 3 of 30 GB and a slave node 4 of 30 GB) based on the resources/storage required for the at least one operation. Then the master node 206a requests the controller 108 to add the slave node 3 and the slave node 4 before execution of the at least one operation in order to avoid the failure of the at least one operation. Thus, the slave nodes can be horizontally scaled without depending on the vertical scaling of the master node 206a.

Further, as depicted in FIG. 5, the slave nodes 3 and 4 can be added to the cluster 110 through the HSG interface. The slave nodes 3 and 4 can automatically registers on the master node 206a using the template for auto commission and the IP address of the master node 206a. The master node 206a can store the information about the registered slave nodes 3 and 4 (such as their IP addresses or the like) in the IP pool 204 coupled with the database 202.

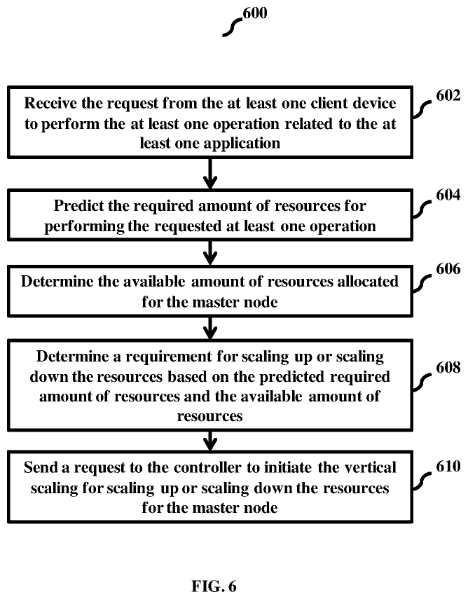

FIG. 6 is an example flow diagram 600 depicting a method for performing the vertical scaling, according to embodiments as disclosed herein. At step 602, the master node 206a receives the request from the at least one client device 102 to perform the at least one operation related to the at least one application hosted on the associated computing cluster 110 of the master node 206a. The at least one operation involves at least one of storing the data related to the at least one application, and processing the data related to the at least one application.

At step 604, the master node 206a determines the required amount of resources for performing the requested at least one operation on receiving the request from the client device 102. The master node 206a collects the metrics of its own, and metrics of the slave nodes 206b such as, but not limited to, load, health, and so on. The master node 206a analyzes the collected metrics and the received request to predict the required amount of resources for performing the at least one operation.

At step 606, the master node 206a determines the available amount of resources allocated for it. At step 608, the master node 206a determines a requirement for scaling up or scaling down the resources based on the determined required amount of resources and the available amount of resources. The master node 206a compares the available amount of resources with the determined required amount of resources. If the available amount of resources on the master node 206b is less than the determined amount of resources, the master node 206a determines that there is a requirement for scaling up/adding the resources and determines the additional amount of resources for scaling up. If the available amount of resources on the master node 206b is more than the determined amount of resources, the master node 206a determines that there is a requirement for scaling down/removing the resources and determines the amount of resources for scaling down.

At step 610, the master node 206a sends a request to the controller 108 to initiate the vertical scaling for scaling up or scaling down the resources for it. On receiving the request from the master node 206a for scaling up the resources, the controller 108 allocates the determined additional amount of resources to the master node 206a for performing the at least one operation. On receiving the request from the master node 206a for scaling down the resources, the controller 108 de-allocates the determined amount of resources from the master node 206a, so that the resources can be efficiently utilized for performing the at least one operation, which reduces computation power and increases performance of the computing cluster 110. The various actions in method 600 may be performed in the order presented, in a different order or simultaneously. Further, in some embodiments, some actions listed in FIG. 6 may be omitted.

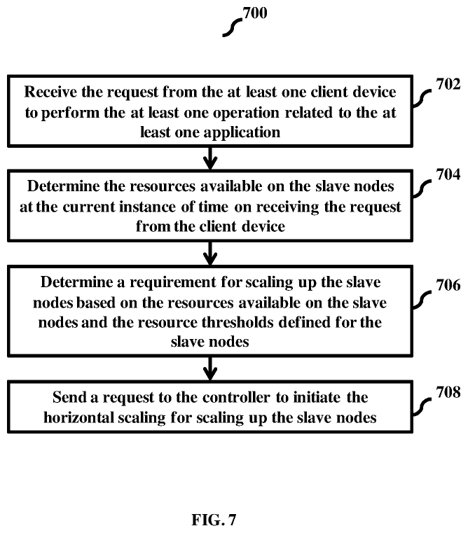

FIG. 7 is an example flow diagram 700 depicting a method for performing the horizontal scaling, according to embodiments as disclosed herein. At step 702, the master node 206a receives the request from the client device 102 to perform the at least one operation related to the at least one application hosted on the associated computing cluster 110. At step 704, the master node 206a determines the resources available on the slave nodes 206b at the current instance of time on receiving the request from the client device 102. The master node 206a collects the information about the slave nodes 206b from the database 202, the metrics from the slave nodes 206b and analyzes the collected information, and the metrics to determine the resources available on the slave nodes 206b.

At step 706, the master node 206a determines a requirement for scaling up the slave nodes 206b based on the resources available on the slave nodes 206b and the resource thresholds defined for the slave nodes 206b. The master node 206a compares the resources available on the slave nodes 206b with the resource thresholds defined for the respective slave nodes 206b. If the resources available on all the slave node 206b are lesser than their respective resource thresholds, the master node 206a determines the requirement for scaling up the slave nodes 206b.

At step 708, the master node 206a sends a request to the controller 108 to initiate the horizontal scaling for scaling up the slave nodes 206b. On receiving the request from the master node 206a for the horizontal scaling, the controller 108 adds the additional number of slave nodes 206b to the cluster 110, so that failure of the data storage operations can be reduced and processing of the stored data can be performed with the high speed. The various actions in method 700 may be performed in the order presented, in a different order or simultaneously. Further, in some embodiments, some actions listed in FIG. 7 may be omitted.

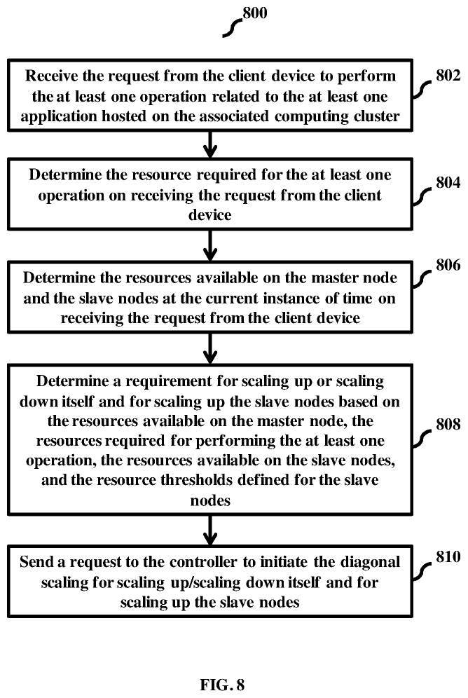

FIG. 8 is an example flow diagram 800 depicting a method for performing the diagonal scaling, according to embodiments as disclosed herein. At step 802, the master node 206a receives the request from the client device 102 to perform the at least one operation related to the at least one application hosted on the associated computing cluster 110. At step 804, the master node 206a determines the resource required for the at least one operation on receiving the request from the client device 102. At step 806, the master node 206a determines the resources available on the master node 206a and the slave nodes 206b at the current instance of time on receiving the request from the client device 102. The master node 206a collects the metrics of its own, and of the slave nodes 206b and analyzes the collected metrics to determine the resources available on the master node 206a, and the slave nodes 206b.

At step 808, the master node 206a determines a requirement for scaling up or scaling down itself and for scaling up the slave nodes 206b based on the resources available on the master node 206a, the resources required for performing the at least one operation, the resources available on the slave nodes 206b, and the resource thresholds defined for the slave nodes 206b. The master node 206a compares its available resources with the resources required for the at least one operation and the resources available on the slave nodes 206b with the resource thresholds defined for the respective slave nodes 206b. If the resources available on the master node 206b are lesser/greater than the required resources for the at least one operation and the resources available on all the slave node 206b are lesser than their respective resource thresholds, the master node 206a determines the requirement for scaling up/scaling down itself and for scaling the slave nodes 206b.

At step 810, the master node 206a sends a request to the controller 108 to initiate the diagonal scaling for scaling up/scaling down itself and for scaling up the slave nodes 206b. On receiving the request from the master node 206a for the diagonal scaling, the controller 108 scales up/scales down the master node 206a by allocating/removing the resources for the master node 206a and adds the additional number of slave nodes 206b to the cluster 110. The various actions in method 800 may be performed in the order presented, in a different order or simultaneously. Further, in some embodiments, some actions listed in FIG. 8 may be omitted.

The embodiments disclosed herein can be implemented through at least one software program running on at least one hardware device and performing network management functions to control the elements. The elements shown in FIGS. 1-5 can be at least one of a hardware device, or a combination of hardware device and software module.

The embodiments disclosed herein describe methods and systems for automated scaling of computing clusters. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

We claim:

1. A distributed computing system (100) comprising:
a plurality of client devices (102); and
a host (104) including a controller (108) and at least one computing cluster (110), wherein the at least one computing cluster (110) comprises a plurality of slave nodes (206b) and at least one master node (206a) coupled to the plurality of slave nodes (206b) and the controller (108), wherein the at least one master node (206a) is configured to:
receive at least one request from at least one client device (102) for performing at least one operation related to at least one application hosted on the at least one computing cluster (110);
determine at least one of a vertical scaling, a horizontal scaling, and a diagonal scaling for scaling the at least one computing cluster (110) to perform the requested at least one operation related to the at least one application; and
send at least one scaling request to the controller (108) for initiating the determined scaling.

2. The distributed computing system (100) of claim 1, wherein performing the at least one operation includes at least one of storing data related to the at least one application, and processing the data related to the at least one application.

3. The distributed computing system (100) of claim 1, wherein the vertical scaling includes at least one of allocating and de-allocating at least one additional amount of resources for the at least one master node (206a).

4. The distributed computing system (100) of claim 1, wherein the horizontal scaling includes allocating at least one additional slave node (206b) to the at least one computing cluster (110).

5. The distributed computing system (100) of claim 1, wherein the diagonal scaling includes a combination of the horizontal scaling and the vertical scaling.

6. The distributed computing system (100) of claim 1, wherein the at least one master node (206a) is further configured to:
determine that the master node (206a) requires the at least one additional amount of resources for performing the requested at least one operation;
determine the at least one additional amount of resources required for the at least one master node (206a); and
determine the vertical scaling for allocating the determined at least one additional amount of resources for the master node (206a).

7. The distributed computing system (100) of claim 6, wherein the at least one master node (206a) is further configured to:
collect at least one metric of the at least one master node (206a);
analyze the collected at least one metric and the received at least one request from the at least one client device (102) to determine at least one required amount of resources for performing the at least one operation using a maintained mapping of required amount of resources with a plurality of operations of a plurality of applications, wherein the determined at least one required amount of resources includes at least one minimum required amount of resources and at least one maximum required amount of resources, wherein the at least one minimum required amount of resources represents a downscale limit of resources and maximum amount of resources represents a upscale limit of resources;
determine at least one available amount of resources on the master node (206a) based on the collected at least one metric of the at least one master node (206a); and
determine that the at least one master node (206a) requires the at least one additional amount of resources based on the determined at least one required amount of resources and the at least one available amount of resources.

8. The distributed computing system (100) of claim 7, wherein the at least one master node (206a) is further configured to:
compare the at least one available amount of resources on the master node (206a) with the at least one minimum required amount of resources and the at least one maximum required amount of resources; and
determine that the at least one master node (206a) requires the at least one additional amount of resources if the at least one available amount of resources is less than the at least one minimum required amount of resources.

9. The distributed computing system (100) of claim 6, wherein the at least one master node (206a) is further configured to:
determine at least one underutilized amount of resource on the at least one master node (206a) based on the determined at least one required amount of resources and the at least one available amount of resources; and
determine the vertical scaling for de-allocating the at least one underutilized amount of resources from the master node (206a) on determining that the at least one underutilized amount of resource on the at least one master node (206a).

10. The distributed computing system (100) of claim 9, wherein the at least one master node (206a) is further configured to:
compare the at least one available amount of resources on the at least one master node (206a) with the at least one minimum required amount of resources and the at least one maximum required amount of resources; and
determine that at least one underutilized amount of resource on the at least one master node (206a) if the at least one available amount of resources is more than the at least one maximum required amount of resources.

11. The distributed computing system (100) of claim 1, wherein the at least one master node (206a) is further configured to:
determine at least one available resource on the plurality of slave nodes (206b) of the at least one computing cluster (110) for performing the at least one requested operation;
determine a requirement for the at least one additional slave node (206b) for performing the requested at least one operation based on the determined at least one available resource on the plurality of slave nodes (206b) and at least one resource threshold associated with the plurality of slave nodes (206b); and
determine the horizontal scaling for allocating the at least one additional slave node (206b) to the at least one computing cluster (110).

12. The distributed computing system (100) of claim 11, wherein the at least one master node (206a) is further configured to:
collect the at least one metric of the plurality of slave nodes (206b);
analyze the collected at least one metric to determine the at least one available resource on the plurality of slave nodes (206b) of the at least one computing cluster (110).

13. The distributed computing system (100) of claim 11, wherein the at least one master node (206a) is further configured to:
compare the at least one available resource on the plurality of slave nodes (206b) with the at least one resource threshold associated with the plurality of slave nodes (206b) of the at least one computing cluster (110); and
determine the requirement for allocating the at least one additional slave node (206b) if the at least one available resource on the plurality of slave nodes (206b) is less than the at least one resource threshold associated with the plurality of slave nodes (206b).

14. The distributed computing system (100) of claim 1, wherein the at least one master node (206a) is further configured to:
determine the at least one available resource on the at least one master node (206a), and the at least one available resource on the plurality of slave nodes (206b) of the at least one computing cluster (110) based on the at least one metric of the at least one master node (206a) and the plurality of slave nodes (206b);
compare the at least one available resource on the at least one master node (206a) with the at least one resource required for performing the requested at least one operation, and the least one available resource on the plurality of slave nodes (206b) with the at least one resource threshold associated with the plurality of slave nodes (206b); and
determine a requirement for allocating the at least one additional amount of resource for the at least one master node and for allocating the at least one additional slave node (206b) to the at least one computing cluster (110) if the at least one available resource on the at least one master node (206a) is less than the at least one resource required for performing the requested at least one operation, and the least one available resource on the plurality of slave nodes (206b) is less than the at least one resource threshold associated with the at least one slave node (206b); and
determine the diagonal scaling for allocating the at least one additional amount of resource to the at least one master node (206a) and the at least one additional slave node (206b) to the at least one computing cluster (110).

15. A method for scaling at least one computing cluster (110) including at least one master node (206a) and a plurality of slave nodes (206b) in a distributed computing system (100), the method comprising:
receiving, by the at least one master node (206a), at least one request from at least one client device (102) for performing at least one operation related to at least one application hosted on the at least one computing cluster (110);
determining, by the at least one master node (206a), at least one of a vertical scaling, a horizontal scaling, and a diagonal scaling for scaling the at least one computing cluster (110) to perform the requested at least one operation related to the at least one application; and
sending, by the at least one master node (206a), at least one scaling request to a controller (108) of a host (104) for initiating the determined scaling.

16. The method of claim 15, wherein performing the at least one operation includes at least one of storing data related to the at least one application, and processing the data related to the at least one application.

17. The method of claim 15, wherein the vertical scaling includes at least one of allocating and de-allocating at least one additional amount of resources for the at least one master node (206a).

18. The method of claim 15, wherein the horizontal scaling includes allocating at least one additional slave node (206b) to the at least one computing cluster (110)

19. The method of claim 15, wherein the diagonal scaling includes a combination of the horizontal scaling and the vertical scaling.

20. The method of claim 15, wherein determining the vertical scaling for scaling the at least one computing cluster (110) includes:
determining that the master node (206a) requires the at least one additional amount of resources for performing the requested at least one operation;
determining the at least one additional amount of resources required for the at least one master node (206a); and
determining the vertical scaling for allocating the determined at least one additional amount of resources for the master node (206a).

21. The method of claim 20, wherein determining that the master node (206a) requires the at least one additional amount of resources includes:
collecting at least one metric of the at least one master node (206a);
analyzing the collected at least one metric and the received at least one request from the at least one client device (102) to determine at least one required amount of resources for performing the at least one operation using a maintained mapping of required amount of resources with a plurality of operations of a plurality of applications, wherein the determined at least one required amount of resources includes at least one minimum required amount of resources and at least one maximum required amount of resources, wherein the at least one minimum required amount of resources represents a downscale limit of resources and maximum amount of resources represents a upscale limit of resources;
determining at least one available amount of resources on the master node (206a); and
determining that the at least one master node (206a) requires the at least one additional amount of resources based on the determined at least one required amount of resources and the at least one available amount of resources.

22. The method of claim 21, wherein determining that the at least one master node (206a) requires the at least one additional amount of resources based on the determined at least one required amount of resources and the at least one available amount of resources includes:
comparing the at least one available amount of resources with the at least one minimum required amount of resources and the at least one maximum required amount of resources; and
determining that the at least one master node (206a) requires the at least one additional amount of resources if the at least one available amount of resources is less than the at least one minimum required amount of resources.

23. The method of claim 20, the method comprises:
determining, by the at least one master node (206a), at least one underutilized amount of resources on the at least one master node (206a) based on the determined at least one required amount of resources and the at least one available amount of resources; and
determining, by the at least one master node (206a), the vertical scaling for de-allocating the at least one underutilized amount of resources from the master node (206a) on determining the at least one underutilized amount of resource on the at least one master node (206a).

24. The method of claim 23, wherein determining the at least one underutilized amount of resources includes:
comparing the at least one available amount of resources on the at least one master node (206a) with the at least one minimum required amount of resources and the at least one maximum required amount of resources; and
determining the at least one underutilized amount of resources on the at least one master node (206a) if the at least one available amount of resources is more than the at least one maximum required amount of resources.

25. The method of claim 15, wherein determining the horizontal scaling for scaling the at least one computing cluster (110) includes:
determining at least one available resource on the plurality of slave nodes (206b) of the at least one computing cluster (110) for performing the at least one requested operation;
determining a requirement for the at least one additional slave node (206b) for performing the requested at least one operation based on the determined at least one available resource on the plurality of slave nodes (206b) and at least one resource threshold associated with the plurality of slave nodes (206b); and
determining the horizontal scaling for allocating the at least one additional slave node (206b) to the at least one computing cluster (110).

26. The method of claim 25, wherein determining the at least one available resource on the plurality of slave nodes (206b) includes:
collecting the at least one metric of the plurality of slave nodes (206b);
analyzing the collected at least one metric to determine the at least one available resource on the plurality of slave nodes (206b) of the at least one computing cluster (110).

27. The method of claim 25, wherein determining the requirement for the at least one additional slave node (206b) includes:
comparing the at least one available resource on the plurality of slave nodes (206b) with the at least one resource threshold associated with the plurality of slave nodes (206b) of the at least one computing cluster (110); and
determining the requirement for allocating the at least one additional slave node (206b) if the at least one available resource on the plurality of slave nodes (206b) is less than the at least one resource threshold associated with the plurality of slave nodes (206b).

28. The method of claim 15, wherein determining the diagonal scaling for scaling the at least one computing cluster (110) includes:
determining the at least one available resource on the at least one master node (206a), and the at least one available resource on the plurality of slave nodes (206b) of the at least one computing cluster (110) based on the at least one metric of the at least one master node (206a) and the plurality of slave nodes (206b);
comparing the at least one available resource on the at least one master node (206a) with the at least one resource required for performing the requested at least one operation, and the least one available resource on the plurality of slave nodes (206b) with the at least one resource threshold associated with the plurality of slave nodes (206b); and
determining a requirement for allocating the at least one additional amount of resource for the at least one master node and for allocating the at least one additional slave node (206b) to the at least one computing cluster (110) if the at least one available resource on the at least one master node (206a) is less than the at least one resource required for performing the requested at least one operation, and the least one available resource on the plurality of slave nodes (206b) is less than the at least one resource threshold associated with the at least one slave node (206b); and
determining the diagonal scaling for allocating the at least one additional amount of resource to the at least one master node (206a) and the at least one additional slave node (206b) to the at least one computing cluster (110).
